(19) United States
(12) Patent Application Publication
(10) Pub. No.: US 2018/0152966 A1
(43) Pub. Date: May 31, 2018

(54) CENTRAL COORDINATION IN SHARED BANDS

(71) Applicant: MARIANA GOLDHAMER, RAMAT GAN (IL)

(72) Inventor: MARIANA GOLDHAMER, RAMAT GAN (IL)

(21) Appl. No.: 15/822,120

(22) Filed: Nov. 25, 2017

Related U.S. Application Data
(60) Provisional application No. 62/427,183, filed on Nov. 29, 2016.

(51) Int. Cl. H04W 74/08; H04W 16/14; H04W 72/08

(52) U.S. Cl. CPC H04W 74/0808; H04W 72/087; H04W 16/14

(57) ABSTRACT

A method for wireless network operation in a shared spectrum includes defining a central coordinator (101) of wireless nodes (102, 103, 104, 111, 112, 113) operating in a shared band. The spectrum sharing is realized by using listen before talk (LBT) procedures by the neighboring nodes. For each user application a Protocol Data Unit (PDU) session is identified. A channel for information exchange is established between the central coordinator and each wireless node. Messages are transmitted over the established channel to provide information to the central coordinator or to transmit commands from the central coordinator to nodes. The central coordinator receives reports from the wireless nodes regarding performance metrics or operational parameters and responsively adapts the operational parameters of a first node to ensure the optimized PDU session operation of a second node.

### FIELD OF THE INVENTION

This disclosure relates generally to digital communication systems and in particular to cellular systems.

### BACKGROUND OF THE INVENTION

The operation in License-Exempt (LE) or shared bands, such as 5 GHz, includes in both IEEE 802.11 and 3GPP cellular (for example LTE) standards the LBT (Listen Before Talk) based on energy detection or carrier sense for assessing if a channel is occupied or not. While IEEE 802.11 standard sets fixed limits for energy detection, it was demonstrated that flexible limits per Access Point (AP) or per Station (STA) are more suitable for a specific environment.

Both IEEE and 3GPP standards use carrier aggregation, however 3GPP allows for flexibility in choosing the frequency channel (cell) on which is sent the UE control information. IEEE has defined within the IEEE 802.11ac-2013 amendment that the free channel assessment is executed on each used carrier before transmission.

IEEE 802.11-based nodes classify the traffic based on the Differentiated Services (DiffServ) Code Point (DSCP) value in the IP (Internet Protocol) header while LTE (Long Term Evolution) systems and nodes use QCI-based tunneling, where QCI (QoS Class Identifier) is derived from DSCP. The main traffic categories are Expedited Forwarding (low delay, low loss and low jitter), Assured Forwarding (higher drop probability if congestion occurs) and Default Forwarding (best effort).

The management of the operation of a wireless network can be done by a Management entity.

In 3GPP LTE standards TS 36.213 v14.0.0 are defined CQI measurements and in TS 36.214 v14.0.0 are defined the RSSI (Received Signal Strength Indication) measurements to be reported by a UE (User Equipment), while in TS36.423 v14.0.0 are defined protocols for distributed coordination between base stations. A higher layer management entity also exists.

In IEEE 802.11-2012 are defined radio measurements to be reported by a STA (station). A Station Management Entity (SME) may receive the results of the radio measurements and set parameters. The SME, using an SNMP (Simple Network Management Protocol) protocol, can further communicate with a compliant management entity.

Starting with 5 GHz and possibly other frequencies like 3.5 GHz in the U.S.A., the IEEE 802.11-based and 3GPP LTE-based systems can operate within the same band or even in the same channel. However there is no common protocol for management, distributed control or centralized control of the nodes belonging to both technologies.

### SUMMARY

Embodiments of the invention provide methods and apparatuses for wireless network operation in a shared band. Embodiments of the invention utilize a central coordinator which has a full view of a network and may apply policies to enable entities (e.g., nodes) to operate in a shared band.

According to a first embodiment of the invention a method for wireless network operation in a shared spectrum includes defining a central coordinator of neighboring wireless nodes operating in a shared band. The spectrum sharing may be realized by using listen before talk (LBT) procedures by the neighboring nodes. For each user application a Protocol Data Unit (PDU) session is identified. A channel for information exchange is established between the central coordinator and each wireless node. Messages are transmitted over the established channel to provide information to the central coordinator or to transmit commands from the central coordinator to nodes. The central coordinator receives reports from the wireless nodes regarding performance metrics or operational parameters and responsively adapts the operational parameters of a first node to ensure the optimized PDU session operation of a second wireless node.

In some embodiments at least one QoS requirement (e.g., one or more of Maximum Flow Bit Rate, Guaranteed Flow Bit Rate, Priority level, Packet Delay Budget, and Packet Error rate) for a specific flow or PDU session of the second wireless node is specified.

According to another embodiment the PDU session in the second wireless node is mapped to a network slice having at least one policy rule for resource allocation of the second wireless node or for at least one LBT parameter or for both.

The reports transmitted from the first wireless node may include information on whether the node has the capability to modify a threshold of energy detection or of a carrier sense at least in one frequency channel.

In some embodiments the reports transmitted from the wireless nodes include an identifier of the technology used by the wireless node. The technology used by the wireless nodes may be based, for example, on an IEEE or on a 3GPP standard. Wireless nodes using IEEE technology can use an SNMP protocol for transmitting reports to the central coordinator and nodes using 3GPP technology can use a 3GPP-developed protocol for transmitting reports to the central coordinator. In some embodiments the wireless nodes using the IEEE technology and the wireless nodes using the 3GPP technology use the same protocol for communicating with the central coordinator.

In some embodiments the reports transmitted from the wireless nodes include at least one parameter from a list including: used threshold for energy detection, used threshold for carrier sense, used defer duration, and maximum used contention window.

The reports transmitted from the wireless nodes may include at least one element from a list including: identifier(s) of the operating frequency channel(s), maximum transmission power, and list of the aggregated channels.

In some embodiments the central coordinator enforces policy rules per PDU session or QoS flow by requesting the first wireless node or the second wireless node to change at least one parameter from frequency channel and medium access parameters in the frequency channel. The medium access parameters may include at least one parameter such as: energy or carrier sense energy threshold, maximum or medium occupancy duration, minimum or maximum contention window duration, and value of defer duration.

According to other embodiments the reports transmitted from the wireless nodes include at least one report from a list including: coupling loss between one node and another node, flow bit rate, packet delay, packet error rate, per-transmission medium occupancy, power level measured during reception, SINR during reception, power levels measured during idle intervals, interference power measured on zero-power CSI-RS reference signals, percentage of time in which each monitored channel was busy or free relative to an energy detection threshold or relative to carrier sense threshold.

The reports may be presented by using at least one processing method such as average value computation, maximum value computation, and a representative value resulting from a Cumulative Distribution Function.

In another embodiment a measurement duration which includes a time-stamp (e.g., start time or stop time), is associated with the reports.

In some embodiments the second wireless node may request from the central coordinator a change of at least one parameter pertaining to operation of the first wireless node or to operation of the second wireless node. The parameter may be at least one of LBT threshold, transmitter power, delay, retransmission number, and repetition coding. In some embodiments the duration of the change is specified.

In some embodiments the central coordinator sends a message to the first wireless node requesting that a specific channel or part of a channel will not be used for a specified period of time. The central coordinator may also send a message to the first wireless node requesting to reduce occupancy of a channel. The occupancy of the channel may be expressed, for example, as a percentage of communication time.

In one embodiment a wireless apparatus is provided. The apparatus may include a radio interface, configured for communicating over a wireless network in a shared band and for using Listen Before Talk (LBT) procedures for spectrum sharing, and a communication interface, configured for exchange of messages with a central coordinator of neighboring wireless nodes operating in a shared band. The apparatus may further include a processor configured to identify a Protocol Data Unit (PDU) session for each user application and to establish a channel for information exchange with a central coordinator via the communication interface. The processor may also transmit reports to the central coordinator regarding performance metrics or operational parameters and receive messages from the central coordinator over the established channel requesting the communication apparatus to change its operational parameters with operational parameters provided by the central coordinator so as to ensure the optimized PDU session operation of another neighboring node.

In some embodiments the radio interface and the processor are configured to behave as a base station, access point, user equipment and/or a non-AP station.

Embodiments of the invention further provide a computing platform which includes a communication interface, configured for exchange of messages with at least two neighboring wireless nodes operating in a shared band and using the listen before talk (LBT) for spectrum sharing; and a processor, which is configured to act as a central coordinator and to establish a channel for information exchange with the at least two wireless nodes via the communication interface. The processor may also receive reports from the at least two wireless nodes regarding performance metrics or operational parameters and may transmit messages over the established information channel for adapting the operational parameters of a first wireless node so as to ensure the optimized PDU session operation of a second neighboring node.

### BRIEF DESCRIPTION OF THE DRAWINGS

The drawings do not represent an exhaustive representation of the possible embodiments of the invention and the invention is not limited to the arrangements presented in the drawings.

The drawings are:

FIG. 1 represents the system architecture, in accordance with an embodiment of the present invention.

FIG. 2 represents a UE/STA block diagram, in accordance with an embodiment of the present invention.

FIG. 3 represents an AP/base station/R-TP (Radio Transceiver Point) block diagram, in accordance with an embodiment of the present invention.

FIG. 4 represents a block diagram of a Central Coordinator, in accordance with an embodiment of the invention.

### DETAILED DESCRIPTION

Embodiments of the invention are described hereinafter in conjunction with the figures.

The following description uses terminology familiar to those skilled in wireless cellular networks and in particular in 3GPP LTE and IEEE 802.11 technologies. This terminology should not be considered as a limitation for the applicability of the invention to other wireless technologies including evolving cellular technologies.

eNB or base station (BS) denotes all types of base stations, including macro, micro, pico, femto or home base station, small cell eNB, relays, remote radio heads, in distributed or centralized architecture, including C-RAN architecture.

In this document a “node” may denote a base station or an Access Point STA (AP) or a UE (User Equipment) or a non-AP station (STA) or an R-TP.

A node can operate in multiple frequency bands and channels; the used frequency band/channel is identified by a channel number and in 3GPP LTE also by a physical Cell-ID.

A Central Coordinator is a logical entity and may be a software module placed on a computing platform, on a base station, on a server located at the network edge (routers, etc.), on Internet, in the core network, in the Operation and Maintenance system, or in any other suitable location. Alternative names could be controller or manager of the network.

In this invention the Central Coordinator (CCord) communicates with the wireless network nodes through a protocol, i.e. network layer signaling procedures.

Several communication approaches are possible, for example:
A. CCord uses the SNMP protocol for communicating with nodes based on IEEE technology and 3GPP protocols (similar to X2) for communicating with LTE or further generations—based entities using 3GPP-developed technologies;
B. CCord uses a C1 protocol (similar to X2) for communicating with both IEEE-based and 3GPP-based entities;
C. CCord uses a mix of protocols.

Listen Before Talk (LBT) is a procedure assessing if the wireless medium is free or occupied. LBT can be performed by using carrier sense or energy detection. In this document LBT indicates collectively the ways mentioned above for assessing whether the medium is free or occupied.

In addition, the IEEE 802.11 management beacons or messages between the wireless nodes can include the medium reservation for a given time.

### System Description

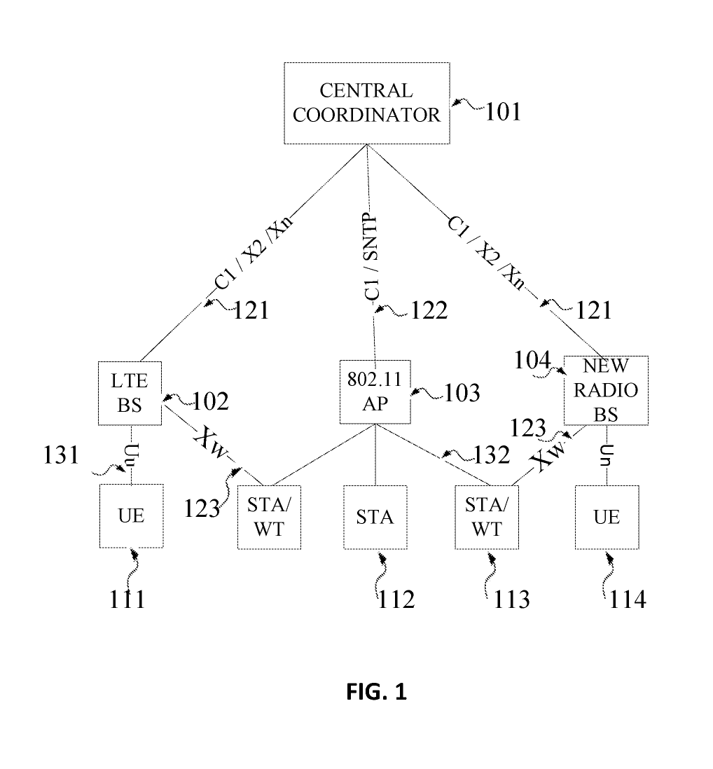

A system example, according to an embodiment of the invention, is described in FIG. 1. In one embodiment the system includes the following basic elements:
A. A Central Coordinator—101 communicating with a 3GPP LTE-based or New Radio (NR, 5G)-based base station—104 using X2 or Xn or C1 (a new protocol)—121 and with an AP 103 using SNMP or a C1 protocol—122, the Central Coordinator—101 having the role of coordinating the operation of the system to improve one or more performance indicators;
B. A 3GPP LTE—based base station—102 using at least one frequency band in a shared spectrum, for example 5 GHz;
C. A New Radio (5G)—based base station—104 using at least one frequency band in a shared spectrum, for example 5 GHz;
D. An IEEE 802.11—based Access Point—103 using at least one frequency band shared with the LTE-based base station—102 or with the New Radio-based base station—104;
E. A UE (User Equipment)—111 communicating with the LTE base station—102 by using an air protocol Uu—131 developed in 3GPP.
F. A UE (User Equipment)—114 communicating with the New Radio-based base station—104 using a new air protocol developed in 3GPP and implementing the New Radio (NR, 5G) technology;
G. A STA 112 communicating with the AP 103 using the IEEE 802.11 air protocol;
H. A STA which is also a WT (WLAN termination)—113 delivers data to a cellular subscriber. The WT is connected to the cellular base station through a protocol Xw—123 developed in 3GPP.

In one embodiment, a base station using cellular technology or an Access Point using IEEE 802.11 or 3GPP technology may be implemented with the higher protocol stacks on a computing platform and with the lower protocol stacks on physical units including radios and antennas (R-TP, i.e. Radio Transceiver Point).

### Registration to Central Coordinator (CCord) and Initial Operation

In the centralized approach, before starting the operation, each infrastructure node (e.g., AP, base station) must listen to the environment and also register to the CCord by setting-up a logical interface for communication.

By listening to the environment, it is possible for a node to detect surrounding nodes and the RSSI (received signal strength indication) power. Depending on the supported technologies, for some of the nodes it is possible to detect also the surrounding node ID or Cell ID.

The information provided at interface set-up can include one or more Information Elements (IEs) containing information about:
a. Identifier of the node;
b. Node network address, for example the IP address;
c. Location name or GPS position of the node;
d. Supported standards or technologies;
e. Supported frequencies of operation;
f. Type of LBT used (energy detection, which can be with a fixed threshold or variable threshold, carrier sense, which can be with a fixed threshold or variable threshold);
g. Capability of LBT per carrier in carrier aggregation;
h. Capability to modify the LBT level (energy detection level or carrier sense level);
i. Medium occupancy limit;
j. Capability of operation related to channel width;
k. Capability of beamforming;
l. Maximum transmitted power;
m. Antenna gain;
n. Type of implementation: virtualized with multiple remote radio units (RRU/R-TP), their ID, their location coordinates;
o. Operator name/ID;
p. Support of infrastructure sharing between operators;
q. Supported network slices, if any;
r. Neighbor nodes ID;
s. RSSI received from a node.

Based on the provided information and also based on the knowledge of other nodes' capabilities and traffic load situation and of the type of traffic, the CCord may send a message including the recommended initial operational channels and the LBT threshold to be used on each possible channel.

As a strategy, the CCord may prefer to group the infrastructure nodes such that nodes using the same technologies will operate on the same channel and avoid the mix on a specific channel of several nodes using different technologies. To this end, the CCord will send a message requesting information regarding the used technology by a node and based on this information will send a message to the selected nodes setting the operating channel(s).

Another strategy may include grouping on the same channel nodes using the same LBT threshold. To this end, the CCord will send a message to the selected nodes setting the operational channel(s) accordingly.

### Operational State

In one embodiment, the CCord will assess, based on a trigger event or periodically, the wireless network operation based on the reports received from the different nodes.

When an infrastructure node starts to transmit on one or more of the recommended frequency channels, the nodes operating in vicinity of the infrastructure node will detect the transmission as a known technology and will report the received power and the transmitting node ID.

If it is not possible to decode the transmitting node ID, the listening node will just sample the received power and memorize it together with a time stamp.

In embodiments of the invention each node sends messages to CCord indicating at least one of the following information:
a. A code for the supported technologies (e.g. 3GPP LTE release number and type of operation, WiFi indicative of technology or IEEE 802.11 indicative of technology, for example the amendment numbers, such as IEEE 802.11 ac);
b. A code for the channel being used;
c. Maximum or average transmission power per node or per channel;
d. Received power (could be RSSI) per node or per channel;
e. A log file containing the MCS of past transmissions to specific UEs and the transmission start time and duration;
f. At least one measurement or a log file containing the MCS of past receptions from specific UEs and the start time and duration of received data;
g. At least one measurement or medium or maximum or minimum values of the measurements or a log file containing the CSI (Channel State Information) or CQI (Channel Quality Indicator) or SINR (signal-to-interference-plus-noise ratio) of the past receptions from specific nodes and the start time and duration of received data;
h. At least one measurement or medium or maximum or minimum values or a log file containing the interference power measured on zero-power CSI-RS reference signals of past receptions or past idle state of specific nodes and the start time and duration of the measurement;
i. At least one measurement or medium or maximum or minimum values or a log file containing the power measured as RSSI of past receptions or past idle state of specific nodes on the operating channel(s) and the start time and duration of the measurement;
j. At least one measurement or medium or maximum or minimum values or a log file containing the power measured as RSSI of past idle state of specific nodes on at least one non-operating channel and the start time and duration of the measurement.

Each node reports one or more parameters as indicated below:
a. Percentage of time in which each monitored channel was busy (relative to energy detection threshold or carrier sense threshold) or free;
b. Its average throughput and peak throughput;
c. Delay due to congestion;
d. Number or percentage of discarded packets by the node;
e. Received power from other nodes either in a statistical form (e.g., average, point on Cumulative Distribution Function (CDF)) or as a list of samples.

Once the transmitting node provides the CCord, through a message, the time stamp of the transmission start and stop and the transmission power, the CCord requests from the other nodes reports regarding the received power during these intervals. The reports may provide the sampled received power levels or a statistical representation including the average power and the power at some specific points on the CDF, for example 90%.

Based on this information CCord may create a better representation on the interference created by a node to other nodes from the same or different technologies and calculate the coupling loss between the node and the other nodes.

The coupling loss, defined as the linear rapport between the transmitted power at a node and the received power of another node, will allow, for example, assessing the created interference. In embodiments of this invention it is possible to limit the transmission power for increasing the frequency reuse factor or to request the use of a low LBT detection threshold for increasing the coverage of another node or for increasing the SINR for delivery of higher user throughput of another node or for higher probability of successful reception by another node.

### Dependency on the Traffic Type

Each user application may have specific requirements, for example, high data rates for streaming video, low latency for V2X (Vehicle to Everything) and high reliability for IoT (Internet of Things). However the requirements for the streamed video are different if the video is used by a robot in a factory as compared with the commercial video streaming.

IEEE 802.11 uses Access Categories (AC) for establishing the minimum and maximum size of the contention window (CW) and the exponential back-off of the CW for accessing the medium. The AC is based on the QoS (Quality of Service), derived from DiffServ DSCP.

In the existing cellular networks, such as 3GPP LTE, the QoS is marked by QCI; each bearer is constructed based on QCI and the QCI values are used for establishing priorities.

In the next generation 5G networks the Service Level Agreement establishes policy rules for the transport of a traffic flow, identified by a flow ID (Identifier). The policy rules may alter the priorities carried by the native DSCP marking or by the QoS requirements of the application.

In order to provide the delivery of traffic so as to match both the policy rules and the native QoS requirements, it is needed that CCord will be aware, by reports, of the flow ID, associated policy rules and the native QoS for a specific traffic flow. A policy rule could include the values for the maximum throughput or the maximum delay or the reliability (percentage of discarded packets), established by the network based on QoS requirements of the application.

The QoS parameters per Service Data Flow (SDF) may include, for example:
a. Maximum Flow Bit Rate;
b. Guaranteed Flow Bit Rate: the bitrate (Minimum or Guaranteed bitrate per flow) that is required for the service to be delivered with sufficient QoE (Quality of Experience);
c. Priority level;
d. Packet Delay Budget;
e. Packet Error rate;
f. Admission control.

A currently new concept in 3GPP is the definition of PDU (Protocol Data Unit) sessions (see TR 23.799 V1.1.0 (2016-10)), where each PDU session is mapped to a separate transport network bearer in order to separate them even if the contained packets have an overlapping IP address range. Also the UE must be able to determine which IP packet belongs to which PDU session in order to transmit the packets correctly and enforce the QoS requirements. For example, a PDU session for transmitting the video streamed by a robot requires very short latency when compared with a PDU session for commercial streaming, even if both sessions are marked in the existing networks with the same video priority. There may be several PDU sessions per UE, each one with different requirements.

In 3GPP 5G networks the traffic generated by an application or its agents will be categorized in both downlink and up-link into flows using TFT (Traffic Flow Template) packet filters (for example source ip address, port number, destination ip address, flow label and eventually IP protocol type) and each such flow can have an identifier to be carried by each transported packet of a PDU session.

The traffic belonging to a PDU session may be served by several technologies, for example, WiFi (technology based on the IEEE 802.11 standards) and 3GPP LTE or other cellular technology.

In embodiments of this invention the actual QoS parameters achieved by each used technology in transporting the user data belonging to a PDU session are reported by sending a message to the CCord.

The access stratum maps the bearers or QoS flows to the appropriate DRB (Data Radio Bearer), each DRB having a dedicated queue, which is of direct relevance to the QoS over radio.

A PDU session, containing one or more QoS flows, could be mapped to a network slice, including a number of policy rules for resource allocation.

In embodiments of this invention the policy rules are translated into radio parameters for operation in a shared band. While the translation of the policy rules can be done locally in a distributed mode, a Central Coordinator having the full view of the network can make this translation in an optimal mode.

In an embodiment of this invention, the application type, possibly represented by a flow ID or a PDU session ID, and if available, an estimation of the duration of the active state, are reported by the node to the CCord, for improving its decisions.

In particular, a node may request from the CCord a change of LBT thresholds or transmitted power thresholds or delay or retransmission number or a repetition coding for the reporting node itself or for the other nodes in the network, so as to obtain the desired level of MCS (Modulation and Coding state) for a specific running application or a specific PDU session or a specific flow used in a PDU session. The request may include the duration of the change.

### QoS Enforcement Per Flow or Per Radio Bearer: Reports

Part of QoS enforcement are the reports from the UE/STA/BS/AP to CCord regarding one or more of the actual:
a. Average and maximum Flow Bit Rate or a CDF representative value (e.g. 10%, 90%) for the Flow Bit Rate in the measurement interval;
b. Actual Priority level, reflected by a priority index or the average, the minimum and maximum CW (Contention Window) size and back-off rules;
c. Average, maximum or a CDF representative value (e.g. 10%, 90%) for the packet delay;
d. Average, maximum or a CDF representative value for the Packet Error Rate (PER);

e. Average, maximum or a CDF representative value for the per-transmission medium occupancy.
The infrastructure nodes may relay or tunnel to CCord the reports of the stations of UEs.

Such reports may include per traffic type or per a specific flow:
a. Power levels for transmission and the time-stamp of the transmission start and end;
b. Power levels measured during reception, including a time-stamp, and sampled at regular intervals and presented as a file log or as representative points on a CDF;
c. SINR during reception, including a time-stamp, sampled at regular intervals and presented as a file log or as representative points on a CDF;
d. Power levels measured during idle intervals, including a time-stamp, sampled at regular intervals and presented as a file log or as representative points on a CDF;
e. MCS (modulation and coding scheme) used for transmission;
f. Currently used LBT thresholds;
g. Used priority level reflected by the maximum used CW;
h. Defer duration.

### CCord Actions for OoS Enforcement

The UE is provided with the UE context. Based on this the UE will try to match the policy rules and the QoS requirements adapting its parameters of access to the medium, including the back-off duration per DSCP or per flow, LBT threshold and transmitting power.

However a Central Coordinator can better enforce the policy rules per flow, by selecting the operational channel and the medium access parameters in that channel.

The main medium access parameters are: carrier sense level or energy detection threshold, maximum medium occupancy duration, a rule specifying the maximum contention window and the parameters of exponential back-off and the value of the defer time.

Based on these reports and on the requirements resulting from the QoS related to PDU sessions, flows, and DSCP marking, the CCord may change the allocated frequency channels to each node, transmission power threshold, LBT thresholds, priority level including the CW rules and the defer duration.

### Central Coordinator and Common Protocol

To allow the adaptability of parameters for accessing a common medium by entities belonging to different technologies, in an embodiment of this invention is used at least a common Central Coordinator and eventually a common protocol is implemented by different wireless nodes belonging to different technologies sharing the medium. The common Coordinator shall optimize the access to the medium such that each node will have maximum performance in relation with the performance metrics established by an Operator or resulting from traffic and QoS requirements of the application or of the PDU session.

### Virtual LBT

CCord may ensure that a channel is free by sending a message to the relevant nodes in which it is requested that a specific channel or channels or part of a channel will not be used for a specified period of time, so as to allow transmissions of nodes having problems related to delay or throughput or reliable delivery. This form of resource reservation is termed Virtual LBT.

The virtual LBT duration can be negotiable, for example based on technical arguments or on pricing.

Virtual LBT can be used for enabling higher SNIR for selected IoT traffic, or a selected PDU session or a selected flow or a selected bearer.

In embodiments of this invention the CCord can make available a channel for the operation of nodes using a technology, by asking one or more nodes using another technology to reduce the occupancy of the channel by a given amount.

The occupancy of a channel can be expressed as the percentage of time in which a base station communicates with the associated UEs or as the percentage of time in which an AP communicates with the associated stations or as the percentage of time in which stations communicate between themselves or as the percentage of time in which UEs communicate between themselves.

### Carrier Aggregation

Both IEEE 802.11 and 3GPP LTE use carrier aggregation; in IEEE 802.11 the LBT is used on each carrier separately, but the LBT parameters are the same. CCord may set different LBT thresholds on each aggregated carrier and could set the primary control channel for each UE/STA on a frequency channel selected by it. The effect of this setting is that in the presence of interference above a predetermined or selected threshold only part of the channels will be used.

The LBT threshold selection for a component carrier in Carrier Aggregation may be dependent on the application type using that carrier, for example, a broadcast application may require high coverage hence a low LBT threshold from the neighboring transmitters.

The allocation of the frequency channels to be used for transmission by different nodes can be dependent on the data rate required by the application.

If a low latency and low traffic is requested at one AP/BS to communicate at relatively short distances, but a high latency can be accepted by the BS/APs in vicinity, the best policy could be to use a channel with high LBT threshold for the application requiring low latency and low LBT threshold and multiple channels for the neighboring nodes. The exact allocation depends also on the scheduling policy, for example 3GPP LTE can use per-carrier scheduling as a mode of carrier aggregation.

### MCS Selection

Given that CCord has a better view of the future interference, as result of the information received from the nodes and also based on its commands setting the power and LBT levels, and eventually setting the time-frequency resources reserved by the IEEE 802.11 virtual carrier sense, CCord can give a more accurate prevision of the MCS to be used by the nodes in their communication with other nodes.

The MCS selection can be specific for the application, such that an application requiring low delay can be allowed a higher SINR for increasing the chances of successful reception.

### Communication Between CCord and Application Servers

An application server can provide to a CCord the possibility to communicate, through a protocol, and obtain from the application server information regarding the requirements of the traffic at a more detailed level than provided by the packet marking by DSCP. For example, a differentiation between low delay and high reliability can be made.

Based on both DSCP marking and this information from an application server and transmitted by the CCord through a message to UE/STA, the UE/STA can classify certain traffic as belonging to a specific network slice. The specific network slice identifier can be used for setting threshold values for the LBT threshold and for the transmitted power.

### IoT Traffic

IoT (Internet of Things) packets may be characterized by shortness and lack of sensitivity to delay, while their experienced loss shall be very small; this allows a long TTL (time-to-live) in the network. To the best knowledge of the inventor, this kind of behavior is not supported by the current IETF standards/RFCs and also by the 3GPP QCI table in 3GPP TS 23.203.

In embodiments of this invention, the 3 GPP QCI table is improved by differentiating between priority, which also implies fast delivery, and the discard rate, i.e. new fields need to be introduced for reflecting only high reliability without time constraints.

This can be achieved by adding a QCI value for which, for example, a very long TTL or a condition for low discardibility of the packet from the transmission queue, are explicitly mentioned.

An example of high reliability entry in a QCI table is provided below:

| | Resource | | Packet Delay | Packet Error | Example |
|---|---|---|---|---|---|
| QCI | Type | Priority | Budget | Loss | Services |
| xx | Non-GBR | None | >300 ms | 10⁻⁶ or lower | High |
| | | | | | reliability |
| | | | | | IoT |

### Radar Detection

Radar detection is required in many shared bands.

Given the specific radar pulse waveform the detection is done during receive periods, as long as the energy of the radar signal is high enough relative to the energy of the background signals which interfere with the radar signals. Each AP/BS/STA/UE should be aware of its performance in radar detection.

If a node becomes aware that the interference power and the interference duration make the radar detection with the required precision impossible, the node notifies the CCord, through a message. If the CCord can rely upon another node in the area which can detect the radar, CCord will send a message to the reporting node allowing its operation; otherwise the CCord shall take measures, by sending messages requesting the channel change, to move the interfering or the interfered node to another channel.

### UE/STA/WT Block Diagram

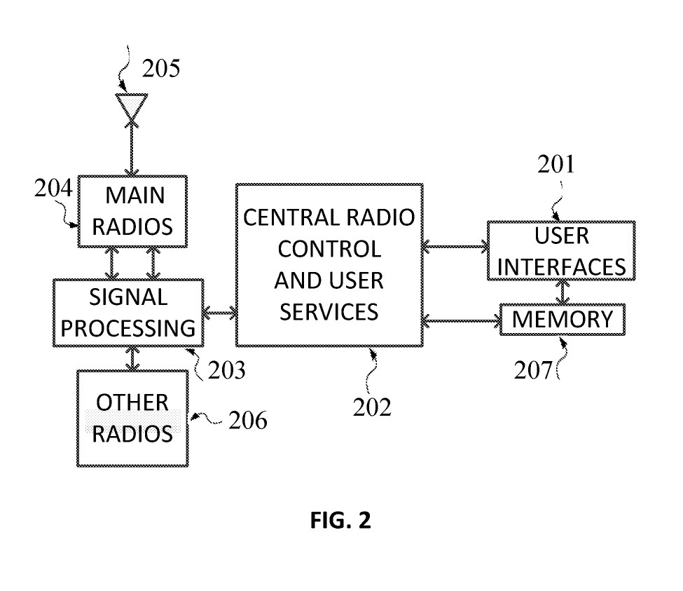

FIG. 2 shows a UE/STA/WT block diagram, according to an embodiment of the invention. A central radio control block, including the functions related to the PHY control and MAC layers, as described in IEEE 802.11-2012 or for LAA operation as described in 3GPP TS 36.300 V14.0.0 (2016-09), is located within a central control unit—202, which may also perform other high-layer user services, including, for example, running applications.

The user interfaces, such as the display, speaker, and microphone, are located in a user interface block—201.

A memory block—207, containing, for example, RAM and non-volatile memory (FLASH or ROM) is used by the central control unit—202 and depending on the actual UE implementation, may be used also by the user interfaces located in block—201.

Digital signal processing is performed by a signal processing block—203 which can provide services to the radios using TDD or packet bursts for communication, such as radios—204, for the cellular operation in licensed and un-licensed bands, and also to other radios—206, such as WiFi and Bluetooth, operating in license-exempt bands. Antennas—205 can be used for receive (RX) and transmit (TX), while using, for example, diplexers or switches.

### AP/BS Implementation

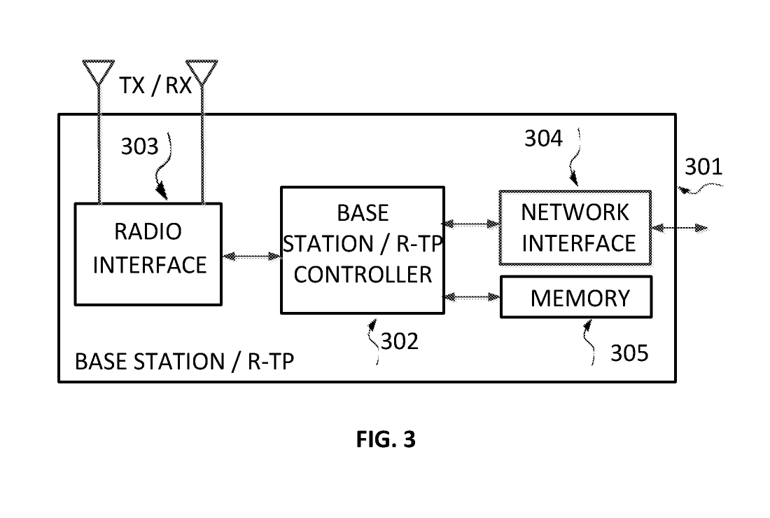

The base station or R-TP blocks shown in FIG. 3 are only by way of example; in practical implementations these blocks can be distributed on multiple circuit boards, and the control functions and hardware functions can be implemented on commercial processors or tailor-made logical arrays, such as system-on-a-chip, FPGAs, ASICs.

The functional blocks of the base station or R-TP 301 include a radio interface—303, providing wireless communication with a UE, the network (communication) interface—304 enabling message transmission over the network, to another base station or to the OAM (Operations, Administration and Maintenance) or to a Central Coordinator.

The controller—302 may include, as a subset of its functions, some functions such as scheduling of the reference signals, configuring and obtaining reports from a UE, including computing functions determining coupling loss or the path loss. The data used by the controller—302 may be stored in a memory block—305.

### Computing Platform

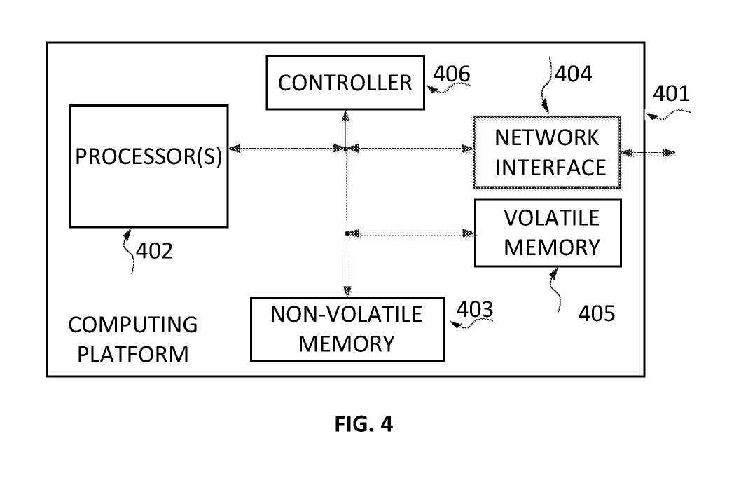

A computing platform, according to one embodiment of the invention, is schematically illustrated in FIG. 4. Computing platform—401 consists of one or more processors—402, non-volatile memory—403, volatile memory—405, a network communication interface—404 and a system controller—406. An application, program or process according to embodiments of the invention may run over an operating system installed in the computing platform 401.

The computing resources of a computing platform can be dynamically allocated to one or more virtual machines, such that each virtual machine can use a number of processor cycles and a partition of the volatile and non-volatile memory.

### Technologies

As will be appreciated by those skilled in the art, the terminology used throughout the specification is mainly associated with the IEEE 802.11 and 3GPP LTE and New Radio (5G) standards. However, it should be understood that embodiments of the present invention encompass other cellular and IEEE standards.

The examples provided herein show certain ways of carrying out the invention. It is to be understood that the invention is not intended to be limited to the examples disclosed herein. Rather, the invention extends to all functionally equivalent structures, methods and uses, as are within the scope of the claims.

1. A method for wireless network operation in a shared band, the method comprising:
using Listen Before Talk (LBT) procedures for spectrum sharing between at least first and second neighboring wireless nodes operating in the shared band;
identifying a Protocol Data Unit (PDU) session associated with a specific user application;
defining a central coordinator of wireless nodes operating in the shared band;
establishing a channel for information and commands exchange between each of the at least first and second wireless nodes operating in the shared band and the central coordinator;
transmitting reports from the wireless nodes to the central coordinator regarding performance metrics or operational parameters; and
responsively adapting the operational parameters of the first wireless node at request of the central coordinator to ensure an optimized PDU session operation of the second wireless node.

2. The method according to claim 1, wherein at least one QoS requirement for a specific flow or PDU session of the second wireless node is specified from a list comprised of: Maximum Flow Bit Rate, Guaranteed Flow Bit Rate, Priority level, Packet Delay Budget, and Packet Error rate.

3. The method according to claim 1, wherein the PDU session in the second wireless node is mapped to a network slice having at least one policy rule for resource allocation of the second wireless node or for at least one LBT parameter or for both.

4. The method according to claim 1, wherein the reports transmitted from the first wireless node include information on whether the node has the capability to modify a threshold of energy detection or of a carrier sense at least in one frequency channel.

5. The method according to claim 1, wherein the reports transmitted from the wireless nodes include an identifier of a technology used by the wireless node.

6. The method according to claim 5, wherein the technology used by the first wireless node or by the second wireless node is based on an IEEE or on a 3GPP standard.

7. The method according to claim 6, wherein wireless nodes using IEEE technology use an SNMP protocol for transmitting reports to the central coordinator and nodes using 3GPP technology use a 3GPP-developed protocol for transmitting reports to the central coordinator.

8. The method according to claim 6, wherein the wireless nodes using an IEEE technology and the wireless nodes using a 3GPP technology use the same protocol for communicating with the central coordinator.

9. The method according to claim 1, wherein the reports transmitted from the wireless nodes include at least one parameter from a list comprised of: used threshold for energy detection, used threshold for carrier sense, used defer duration, and maximum used contention window.

10. The method according to claim 1, wherein the reports transmitted from the wireless nodes include at least one element from a list comprised of: identifier(s) of the operating frequency channel(s), maximum transmission power, and list of the aggregated channels.

11. The method according to claim 1, wherein the central coordinator enforces policy rules per PDU session or QoS flow by requesting the first wireless node or the second wireless node to change at least one parameter from frequency channel and medium access parameters in the frequency channel.

12. The method according to claim 11, wherein the medium access parameters include at least one parameter from a list comprised of: energy or carrier sense energy threshold, maximum or medium occupancy duration, minimum or maximum contention window duration, and value of defer duration.

13. The method according to claim 1, wherein the reports transmitted from the wireless nodes include at least one report from a list comprised of: coupling loss between one node and another node, flow bit rate, packet delay, packet error rate, per-transmission medium occupancy, power level measured during reception, SINR during reception, power levels measured during idle intervals, interference power measured on zero-power CSI-RS reference signals, percentage of time in which each monitored channel was busy or free relative to an energy detection threshold or relative to a carrier sense threshold.

14. The method according to claim 13, wherein the reports are presented using at least one processing method from a list comprised of: average value computation, maximum value computation, and a representative value resulting from a Cumulative Distribution Function.

15. The method according to claim 1, wherein a measurement duration comprising a time-stamp of at least start time or stop time, is associated with the reports regarding performance metrics or operational parameters.

16. The method according to claim 1, wherein the second wireless node requests from the central coordinator a change of at least one parameter pertaining to operation of the first wireless node or to operation of the second wireless node.

17. The method according to claim 16, wherein the parameter is at least one from the list comprised of: LBT threshold, transmitter power, delay, retransmission number, and repetition coding.

18. The method according to claim 16, comprising specifying a duration of the change.

19. The method according to claim 1, where the central coordinator sends a message to the at least one first wireless node requesting that a specific channel or part of a channel will not be used for a specified period of time.

20. The method according to claim 1, wherein the central coordinator sends a message to the at least one first wireless node requesting to reduce occupancy of a channel.

21. The method according to claim 20, wherein the occupancy of a channel is expressed as a percentage of communication time.

22. A wireless apparatus comprising:
a radio interface, configured to communicate over a wireless network in a shared band and to use Listen Before Talk (LBT) procedures for spectrum sharing;
a communication interface, configured to exchange messages with a central coordinator of neighboring wireless nodes operating in a shared band; and
a processor configured to
identify a Protocol Data Unit (PDU) session for a user application;
establish a channel for information exchange with the a central coordinator via the communication interface;
transmit reports to the central coordinator regarding performance metrics or operational parameters; and
receive messages from the central coordinator over the established channel requesting the communication apparatus to change its operational parameters with operational parameters provided by the central coordinator to ensure an optimized PDU session operation of another neighboring node.

23. The apparatus of claim 22, wherein the radio interface and the processor are further configured to behave as at least one apparatus from the list comprised of: base station, access point, user equipment, and non-AP station.

24. A computing platform comprising:
a communication interface configured for exchange of messages with at least two neighboring wireless nodes operating in a shared band and using the listen before talk (LBT) for spectrum sharing; and
a processor configured to
establish a channel for information exchange with the at least two wireless nodes via the communication interface;
receive reports from the at least two wireless nodes regarding performance metrics or operational parameters; and
transmit messages over the established channel for adapting the operational parameters of a first wireless node to ensure an optimized PDU session operation of a second neighboring wireless node.
